(19) United States
(12) Patent Application Publication
(10) Pub. No.: US 2011/0157023 A1
(43) Pub. Date: Jun. 30, 2011

(54) MULTI-TOUCH DETECTION METHOD

(75) Inventors: CHING HSIEN HSU, TAOYUAN COUNTY (TW); JHIH CYUAN YANG, CHANGHUA COUNTY (TW)

(73) Assignee: RITDISPLAY CORPORATION, HSINCHU (TW)

(21) Appl. No.: 12/648,148

(22) Filed: Dec. 28, 2009

(51) Int. Cl. G06F 3/041

(52) U.S. Cl. 345/173

(57) ABSTRACT

A multi-touch detection method is applicable for operating a touch panel with a single button-patterned transparent conductive layer. A system employing the touch panel receives simultaneous inputs of a first button and a second button. Two time series of inputs are obtained from sequential pressing of certain buttons respectively adjacent to the first button and the second button. The positional changes of the two time series of inputs are tracked, and compared with each other so as to recognize a gesture input.

### BACKGROUND OF THE INVENTION

1. Field of the Invention

The present invention relates to a multi-touch detection method, and more particularly, to gesture recognition by processing of time series of positional inputs received by a system employing a touch panel with a button-patterned ITO (indium tin oxide) layer.

2. Description of the Related Art

Touch panels are widely applied in the fields of household appliances, communications, and electronic information devices. Common applications of the touch panel include input interfaces of personal digital assistants (PDA), electrical appliances, and game machines. The current trend of integration of touch panel and display panel allows a user to use his or her finger or a stylus to indicate a control icon shown on the panel in order to is execute a desired function on a PDA, electrical appliance, game machine, etc. The touch panel is also applied in public information inquiry systems to provide an efficient operation system for the public.

A conventional touch panel comprises a transparent substrate having a surface on which sensing zones are distributed for sensing a signal associated with the touch of a user's finger or stylus to effect input and control. The sensing zones are made of transparent conductive membranes, such as indium tin oxide (ITO), and a user may touch the transparent conductive membrane corresponding to a specific location shown on the display to effect operation of the device.

In order to detect the location where a finger or a stylus touches the touch panel, a variety of capacitive touch panel techniques are developed. As shown in FIG. 1, a touch panel 10 comprises a substrate 11 and a transparent conductive layer 12. The transparent conductive layer 12 is patterned and formed on the transparent substrate 11 by a photolithography process, and includes a plurality of touch pads (121, 122), a plurality of inner leads 123, a plurality of outer leads 124, and a plurality of terminals 125. Each of the touch pads (121, 122) is connected to one of the inner leads 123, and the inner lead 123 is connected to one of the outer leads 124. The terminals 125 are respectively connected to one of the outer leads 124, and are electrically connected together to a driver IC (not shown). Each of the buttons (121, 122) can be deemed as an independent switch for activating a corresponding designated function or for choosing a corresponding item.

However, such a touch panel 10 with a single button-patterned transparent conductive layer cannot easily recognize complicated multi-touch gestures such as rotation, zoom in, and zoom out. Therefore, most current touch-control appliances (or portable electronic devices) utilize a is complicated two-dimension touch panel rather than the touch panel 10 to precisely recognize aforesaid complicated multi-touch gestures. However, the two-dimension touch panel needs to be driven by high-level driver ICs, and hence, the cost of the current touch-control electrical appliances with uncomplicated functions is higher than necessary.

Thus, it is desired to improve the conventional and inexpensive touch panel with a button-patterned ITO layer to recognize complicated gestures by processing of time series of positional inputs.

### SUMMARY OF THE INVENTION

An aspect of the present invention is to provide a multi-touch detection method for recognizing complicated multi-touch gestures by processing of time series of positional inputs received by a system employing a touch panel with a button-patterned ITO layer. Therefore, the touch panel with a button-patterned ITO layer can act as a complicated two-dimension touch panel touch panel.

In view of the above, the present invention discloses a multi-touch detection method for operating a touch panel with a single button-patterned transparent conductive layer comprising the steps of: receiving simultaneous inputs of a first button and a second button; detecting two time series of inputs of activated buttons respectively adjacent to the first button and the second button; tracking positional changes of the two time series of inputs; and comparing the positional changes of the two time series of inputs to recognize a gesture input.

According to one embodiment, the present invention discloses a multi-touch detection method for operating a touch panel with a single button-patterned transparent conductive layer comprising the steps of: receiving simultaneous inputs of a first button, a second button and a third button; detecting two time series of inputs of activated buttons adjacent to the first button and the second button, wherein the input of the third button is maintained; tracking positional changes of the two time series of inputs; and comparing the positional changes of the two time series of inputs with the position of the third button to recognize a gesture input.

### BRIEF DESCRIPTION OF THE DRAWINGS

The invention will be described according to the appended drawings in which:

FIG. 1 is a schematic diagram of a conventional touch panel;

FIG. 2 is a flow chart of a multi-touch detection method for operating a touch panel with a single button-patterned transparent conductive layer in accordance with the present invention;

FIGS. 3A and 3B show a rotation gesture to control a touch panel for rotating a display image;

FIGS. 4A and 4B show another rotation gesture to control a touch panel for rotating a display image;

FIG. 5A shows a zoom-out gesture to control a touch panel for zooming out a display image;

FIG. 5B shows a zoom-in gesture to control a touch panel for zooming in a display image; and

FIGS. 6A and 6B respectively show zoom-out and zoom-in gestures to control a touch panel for zooming out and zooming in a display image.

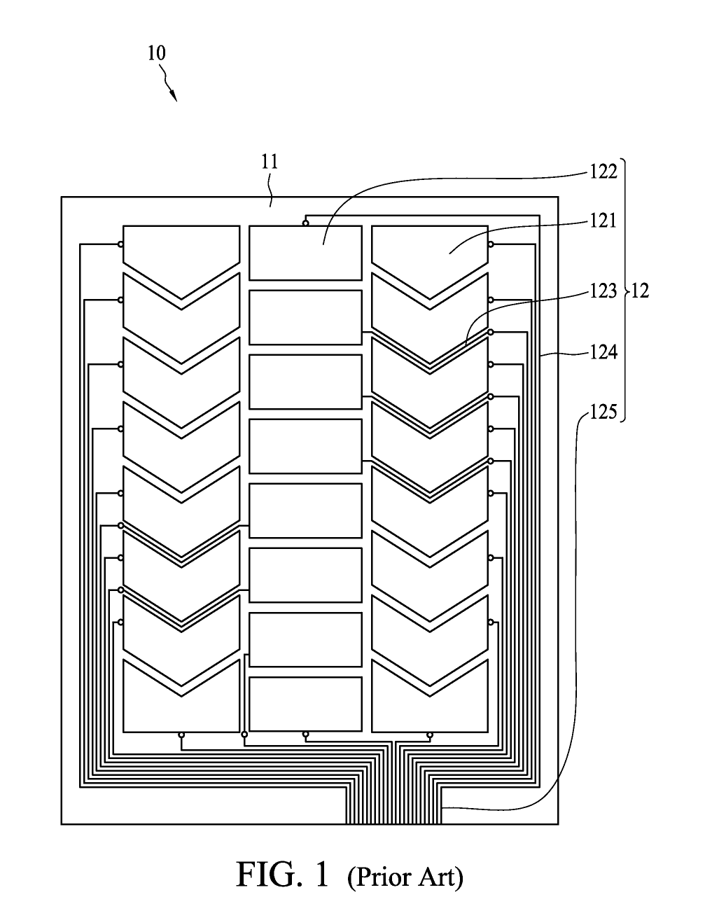

### PREFERRED EMBODIMENT OF THE PRESENT INVENTION

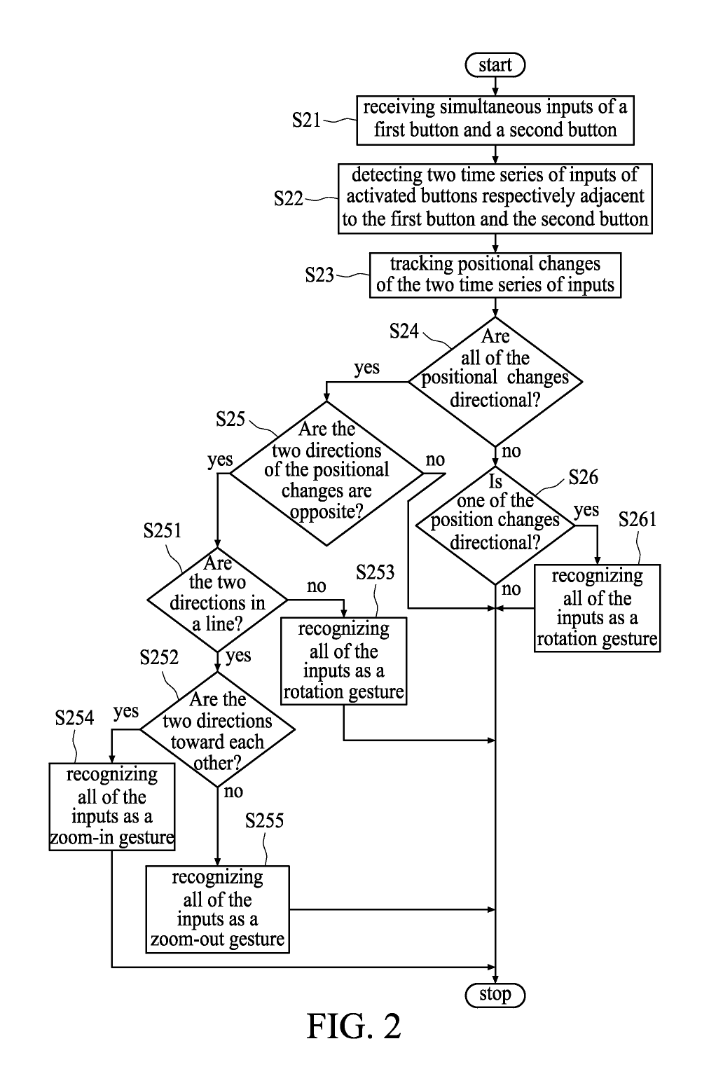

FIG. 2 is a flow chart of a multi-touch detection method for operating a touch panel with a single button-patterned transparent conductive layer in accordance with the present invention. As shown in Step 21, a first button and a second button of a touch panel with a single button-patterned transparent conductive layer are simultaneously pressed by two fingers, and the system employing the touch panel receives the inputs of the first button and the second button. Thereafter, fingertips of the two fingers can slide from the current pressed buttons to next buttons, or can continue to press the same buttons. As shown in Step 22, if the fingertips of the two fingers slide on the buttons, the system obtains two time series of inputs from the activated buttons respectively adjacent to the first button and the second button.

As shown in Step 23, the positional changes of the two time series of inputs of the activated buttons are tracked by the system, so the routes of the two fingertips sliding on the touch panel are known according to the sequentially activated buttons. As shown in Step 24, if all of the positional changes are directional, go to Step 25. That is, all of the two fingers are not motionless and slide on the touch panel, and the finger gesture presented by the two fingers is likely to be a rotating gesture, a zoom-out gesture or a zoom-in gesture.

If at least one of the user's fingers still presses the same button, go to Step 26. When one of the fingers still presses the same button and the other slides on the touch panel, the answer of Step 26 is affirmative and the two time series of the inputs are recognized as a rotation gesture, as shown in Step 261. However, if all of the fingers still press the same button, no gesture is recognized.

If all of the positional changes are directional, the directions of the positional changes are likely to be opposite. When the directions of the positional changes are substantially the same, no gesture is recognized, as shown in Step 25. By contrast, when the directions of the positional changes are opposite, the system needs to confirm whether the two directions are in a line (in the same row or column of the buttons), as shown in Step 251. If the two directions do not align with each other, the two time series of the inputs are also recognized as a rotation gesture, as shown in Step 253.

When the two directions align with each other, the finger gesture presented by the two fingers is likely to be a zoom-out gesture or a zoom-in gesture. Therefore, the system needs to further confirm whether the two directions are toward each other, as shown in Step 252. If the two directions are toward each other, the two fingers approach each other respectively from the first button and the second button. Then, two time series of the inputs are recognized as a zoom-in gesture, as shown in Step 254. If not, two time series of the inputs are recognized as a zoom-out gesture, as shown in Step 255.

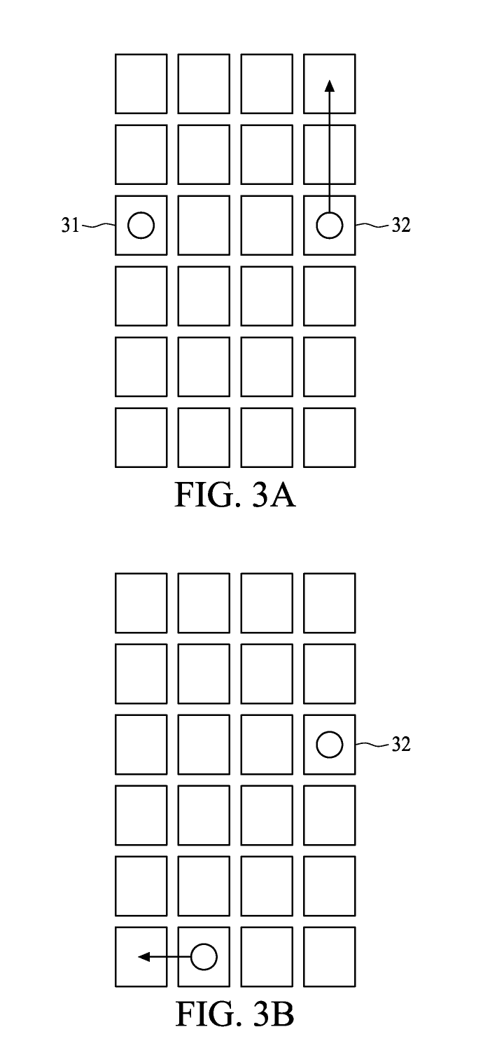

FIGS. 3A and 3B show a rotation gesture to control a touch panel for rotating a display image. The circle in the figures represents an initially pressed button, and the arrow in the figures represents a fingertip slide on a touch panel with sequential activation of the buttons the fingertip passes over. Regarding this embodiment, a fingertip continuously presses on a first button 31, and another fingertip moves along the direction of the arrow from a second button 32 initially pressed. The direction of the arrow relative to the continuously-pressed first button 31 is recognized as a counterclockwise rotation gesture, and then the system will rotate a current display image counterclockwise, as shown in FIG. 3A. By contrast, the direction of the arrow relative to the continuously-pressed second button 32 is recognized as a clockwise rotation gesture, and the system will rotate a current display image clockwise, as shown in FIG. 3B.

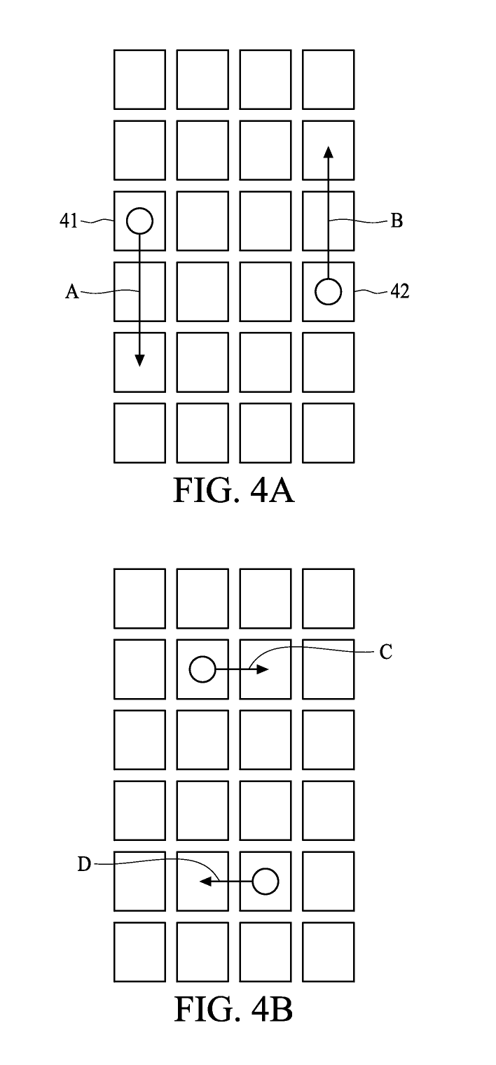

FIGS. 4A and 4B show another rotation gesture to control a touch panel for rotating a display image. Regarding the embodiment, a fingertip moves along the direction of the arrow A from a first button 41 initially pressed, and another fingertip also moves along the direction of the arrow B from a second button 42 initially pressed. The direction of the arrow A is opposite the direction of the arrow B. The directions of the arrows A and B are recognized as a counterclockwise rotation gesture, and the system will rotate a current display image counterclockwise, as shown in FIG. 4A. By contrast, the directions of the arrows C and D are recognized as a clockwise rotation gesture, and the system will rotate a current display image clockwise, as shown in FIG. 4B.

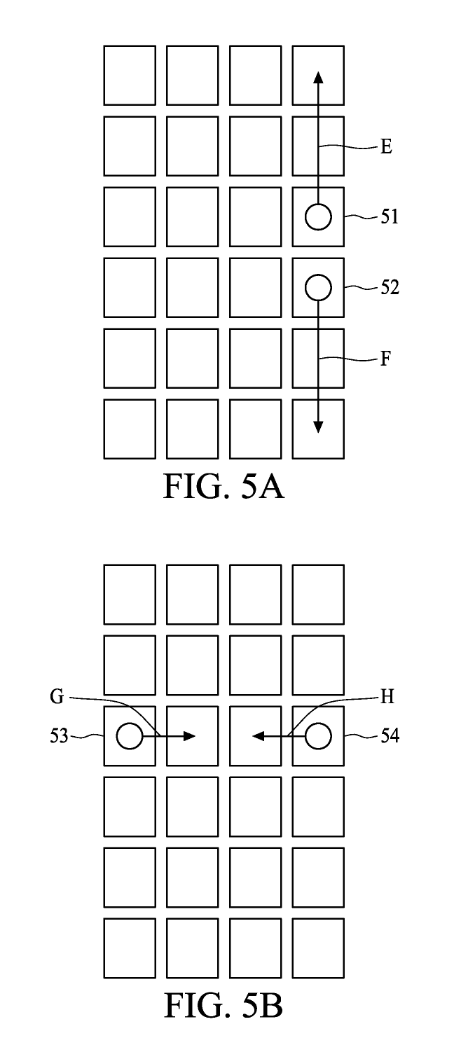

FIG. 5A shows a zoom-out gesture to control a touch panel for zooming out a display image. Regarding the embodiment, a fingertip moves along the direction of the arrow E from a first button 51 initially pressed, and another fingertip also moves along the direction of the arrow F from a second button 52 initially pressed. The direction of the arrow E is aligned with and away from the direction of the arrow F. The directions of the arrows E and F are recognized as a zoom-out gesture, and the system zooms out a current display image.

FIG. 5B shows a zoom-in gesture to control a touch panel for zooming in a display image. Regarding the embodiment, a fingertip moves along the direction of the arrow G from a first button 53 initially pressed, and another fingertip also moves along the direction of the arrow H from a second button 54 initially pressed. The direction of the arrow G is aligned with and toward the direction of the arrow H. The directions of the arrows G and H are recognized as a zoom-in gesture, and the system zooms in a current display image.

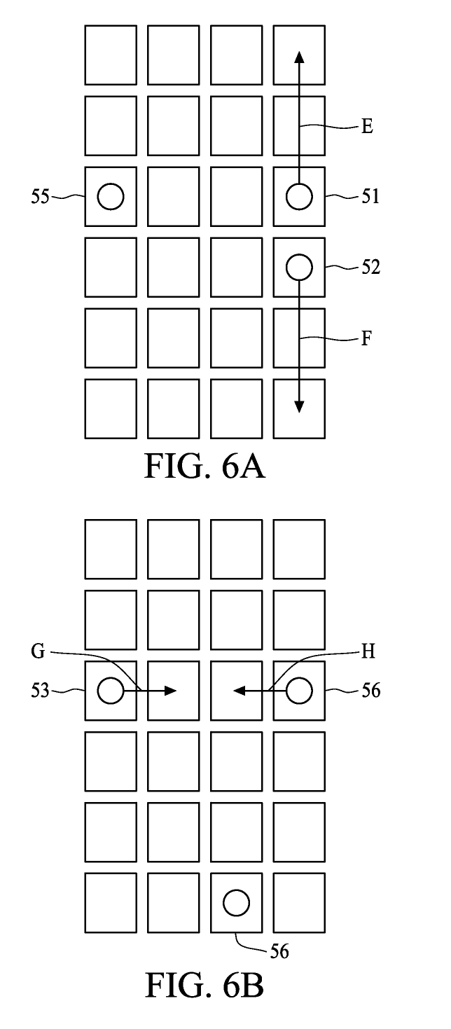

FIG. 6A shows a zoom-out gesture to control a touch panel for zooming out a display image. Compared with FIG. 5A, another finger continuously presses a third button 55, and the directions of the arrows I and J are away from the position of the third button 53. The directions of the arrows I and J are recognized as a zoom-out gesture, and the system zooms out a current display image.

FIG. 6B shows a zoom-in gesture to control a touch panel for zooming in a display image. Compared with FIG. 5B, another finger continuously presses a third button 56, and the directions of the arrows G and H are toward the position of the third button 56. The directions of the arrows G and H are recognized as a zoom-in gesture, and the system zooms in a current display image.

The above descriptions of the present invention are intended to be illustrative only. Numerous alternative methods may be devised by persons is skilled in the art without departing from the scope of the following claims.

1. A multi-touch detection method for operating a touch panel with a single button-patterned transparent conductive layer comprising the steps of:
receiving simultaneous inputs of a first button and a second button;
detecting two time series of inputs of activated buttons respectively adjacent to the first button and the second button;
tracking positional changes of the two time series of inputs; and
comparing the positional changes of the two time series of inputs to recognize a gesture input.

2. The multi-touch detection method of claim 1, wherein the two time series of the inputs are recognized as a zoom-out gesture when each of the positional changes of the two time series of inputs is directional, and two directions of the positional changes are aligned with and away from each other.

3. The multi-touch detection method of claim 1, wherein the two time series of the inputs are recognized as a zoom-in gesture when each of the positional changes of the two time series of inputs is directional, and two directions of the positional changes are aligned with and approaching each other.

4. The multi-touch detection method of claim 1, wherein the two time series of the inputs are recognized as a rotation gesture when each of the positional changes of the two time series of inputs is directional, and two directions of the positional changes are parallel to each other and are opposite from each other.

5. The multi-touch detection method of claim 4, wherein the two time series of the inputs are recognized as a counterclockwise rotation gesture when the two directions of the positional changes are counterclockwise.

6. The multi-touch detection method of claim 4, wherein the two time series of the inputs are recognized as a clockwise rotation gesture when the two directions of the positional changes are clockwise.

7. The multi-touch detection method of claim 1, wherein the two time series of the inputs are recognized as a rotation gesture when one of the positional changes of the two time series of inputs is directional, and the other of the positional changes of the two time series of inputs is motionless.

8. The multi-touch detection method of claim 7, wherein the two time series of the inputs are recognized as a counterclockwise rotation gesture when the direction of the positional change is counterclockwise.

9. The multi-touch detection method of claim 7, wherein the two time series of the inputs are recognized as a clockwise rotation gesture when the direction of the positional change is clockwise.

10. The multi-touch detection method of claim 1, wherein the single button-patterned transparent conductive layer comprises a plurality of buttons including the first button, the second button and the third button, which are individually detected.

11. A multi-touch detection method for operating a touch panel with a single button-patterned transparent conductive layer comprising the steps of:
receiving simultaneous inputs of a first button, a second button and a third button;
detecting two time series of inputs of activated buttons adjacent to the first button and the second button, wherein the input of the third button is maintained;
tracking positional changes of the two time series of inputs; and
comparing the positional changes of the two time series of inputs with the position of the third button to recognize a gesture input.

12. The multi-touch detection method of claim 11, wherein the two time series of the inputs are recognized as a zoom-out gesture when each of the positional changes of the two time series of inputs is directional, and two directions of the positional changes are aligned with and away from each other.

13. The multi-touch detection method of claim 11, wherein the two time series of the inputs are recognized as a zoom-in gesture when each of the positional changes of the two time series of inputs is directional, and two directions of the positional changes are aligned with and approaching each other.

14. The multi-touch detection method of claim 11, wherein the single button-patterned transparent conductive layer comprises a plurality of buttons including the first button, the second button and the third button, which are individually detected.
